(19) United States
(12) Patent Application Publication
(10) Pub. No.: US 2024/0152830 A1
(43) Pub. Date: May 9, 2024

(54) METHOD FOR PRESENTING DATA ABOUT A CONSTRUCTION SITE

(71) Applicant: Robert H. Samuels, Kirkland, WA (US)

(72) Inventor: Robert H. Samuels, Kirkland, WA (US)

(73) Assignee: Robert H Samuels, Kirkland, WA (US)

(21) Appl. No.: 17/984,188

(22) Filed: Nov. 9, 2022

(51) Int. Cl. G06Q 10/06; G06Q 10/10

(52) U.S. Cl. CPC G06Q 10/063114; G06Q 10/063118; G06Q 10/06312; G06Q 10/103

(57) ABSTRACT

A method for presenting data about a construction site on a network of operatively connected computers, comprises the steps of establishing authorized workers at the construction site authorized to complete at least a portion of a pre-task plan which corresponds to the authorized worker, presenting the portion of the pre-task plan to the authorized worker, generating inputs from the authorized worker corresponding to a change in status which are used to create reports, and pushing reports to selected parties on the network based on the inputs from the authorized worker in real-time. In accordance with another aspect, the method comprises the steps of pulling enterprise resource planning data from an enterprise resource planning module into one or more reports about the data of the construction site, wherein the enterprise resource planning data comprises cost codes, generating a report about aspects of the data of the construction site, wherein the report comprises the cost codes, and pushing the report about the aspects of the construction site data to the selected parties.

This patent application claims priority benefit of U.S. Provisional Patent Application 63/277,534, filed on Nov. 9, 2021, and U.S. Provisional Patent Application 63/285,055, filed on Dec. 1, 2021.

### FIELD OF THE INVENTION

This invention relates to methods for presenting data about a construction site, and more particularly to methods for presenting data about a construction site in real-time and generating reports allowing for rapid adjustment to changing conditions.

### BACKGROUND OF THE INVENTION

Construction companies and construction workers have historically resisted procedural automation efforts. Many necessary procedures are still performed manually with low levels of system support and scrutiny, in effect reporting by an honor system. These antiquated methods of reporting and data entry are prone to errors, delays, and excessive management and processing costs, including chasing of subcontractors for productivity information and job site safety management. Only recently the industry has seen some tentative steps aimed at simplifying the process of building and safety. Often construction companies now find they are using multiple software applications to manage the productivity of their companies, employees, contractors, and projects. But often, too many non-integrated software applications in the marketplace claim to improve work conditions and productivity when in fact, they add to the workloads of construction site staff. Further, due in part to a lack of inter-connectivity and integration between these applications, as well as limited integration into company enterprise systems, construction companies have been comfortable keeping the status quo rather than change or adopt innovative ideas or technologies, despite safety risks.

Other problems can include field crews often lacking technical reporting and software application skills, as well as scheduling demands on their time take away from reporting, and in general there can be a lack of field crew buy-in and motivation to complete field reports or follow reporting processes at the end of a shift. Typically, workers don't want to spend time filing out paperwork, and so there is a need to make the presentation to the workers straightforward and efficient. Also, in some instances subcontractors engage in practices such as “Cost Code Hopscotch” or “Cost Code Banking,” where, as an example, worker level reporting may be re-classified in a way that is favorable to the subcontractor, such as classifying an apprentice as a journeyman, or assigning unused cost codes to unrelated project overages or inaccurately logging hours.

Of note, many construction companies believe building costs are unnecessarily inflated to offset these everyday problems, yet even these offsets have not been motivation enough for change, mainly due to widespread perceived difficulties with existing limited automation efforts. It would therefore be desirable to provide a method for presenting data about construction site productivity which reduces the need for many cumbersome third-party applications. This new method should enhance tracking and productivity, as well as required streamline safety and other daily reports. This method should reduce costs and the potential for inaccurate reporting and allow for integration with existing enterprise systems.

### SUMMARY OF THE INVENTION

In accordance with a first aspect, a method for presenting data about a construction site productivity on a cloud network of operatively connected computers and mobile devices, comprises the steps of establishing authorized workers at the construction site authorized to complete at least a portion of a pre-task plan which corresponds to the authorized worker's tasks, presenting the portion of the pre-task plan to the authorized worker, generating inputs from the authorized worker corresponding to a change in status which are used to create reports and pushing reports to selected parties on the network based on the inputs from the authorized worker in real-time. In accordance with another aspect, the method comprises the steps of pulling enterprise resource planning data from an enterprise resource planning module into one or more reports about the data of the construction site, wherein the enterprise resource planning data comprises one or more cost codes, generating a completed report about at least one aspect of the data of the construction site, wherein the completed report comprises the one or more cost codes, and pushing the completed report about the at least one aspect of the construction site data to the selected parties.

From the foregoing disclosure and the following more detailed description of various embodiments it can be apparent to those skilled in the art that the present invention provides a significant advance in the technology of methods for presenting construction site data. Particularly significant in this regard is the potential the invention affords for providing a low cost, easy to use method which allows for real-time tracking of a suite of useful data which can be compared with predictive models with flags to indicate actions to be taken. Additional elements and advantages of various embodiments can be better understood in view of the detailed description provided below.

### BRIEF DESCRIPTION OF THE DRAWINGS

FIG. 1 is an overview of a method for collecting and presenting data about a construction site in accordance with one embodiment.

FIG. 2 is an overview of a method for collecting and presenting data about a construction site in accordance with another embodiment.

FIG. 3 is a schematic of a screen presented on a smart phone of an authorized worker operatively connected to the network.

FIG. 4 is a schematic of part of one floor of a construction site which can be represented on the smart phone/tablet of an authorized worker operatively connected to the network.

FIG. 5 is a schematic of an authorized worker using a tablet to enter inputs corresponding to changes in status of data at the construction site, showing a schematic of at least a part of the construction site represented on a screen of the tablet.

FIG. 6 shows a series of schematic views of screens for an authorized worker to log into the networked system and to show a portion of the construction site that the authorized worker will be working on.

FIG. 7 shows a schematic view of a screen for use by an authorized worker to select a cost code corresponding to the work which has been done.

FIG. 8 shows a schematic view of a screen for use by an authorized worker allowing for input of the number of hours worked on a particular task (under a corresponding cost code).

FIG. 9 shows a schematic view of a screen for use by an authorized worker allowing for input of the items and/or location of work, which was done for a particular task, via touch screen selection.

FIG. 10 is a flow chart of a health screening function.

FIG. 11 is a flow chart of data pulled from authorized workers, pushed to authorized workers, and pushed to selected parties.

FIG. 12 is a flow chart of a daily work day using a pre-task plan in accordance with one embodiment.

It should be understood that the appended drawings are not necessarily to scale, presenting a somewhat simplified representation of various features illustrative of the basic principles of the invention. The specific design features of the components of the method for presenting construction site data as disclosed here, including, for example, the specific type of data input devices used by operators at the site, can be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It can be apparent to those skilled in the art, that is, to those who have knowledge or experience in this area of technology, that many uses and design variations are possible for the method for presenting construction site data disclosed here. The following detailed discussion of various alternate elements and embodiments can illustrate the general principles of the invention with reference to a construction site for a multi-floor building. Other embodiments suitable for other applications can be apparent to those skilled in the art given the benefit of this disclosure. For example, a construction site can comprise construction of a permanent fixture, or a temporary fixture which is assembled and then after use, disassembled.

Disclosed herein is a method tracking daily productivity and process flow data about a construction site and pushing such data into enterprise software systems via a cloud-based software application (app). The app is preferably a web-based application and available to download on most PCs, tablets and mobile devices. The system provides an elegant application programming interface (API) built on REST, HTTP, and JSON, for example, which is easy to use and thereby helps to ensure much higher compliance, while reducing the risk of fraud, and reducing the risk of delays and accidents through enhanced process control. The system comprises a cloud network of operatively connected computers (which would include mobile devices) and can gather and store data continuously and also push job site data and reports useful to management and other selected parties in real-time (or at preset times, such as a daily log or progress report). Data collected can be screened and sorted on an historical and operational basis to validate authenticity before archiving and distributing to appropriate agencies or other selected parties. The system allows the user to work offline in the absence of the Internet and synchronize offline data to the cloud servers. The system, when loaded with instructions for performing tasks as part of the methods described herein, is performed on a machine dedicated to the described methods.

Advantageously, the methods described herein increase system compliance, safety and security.

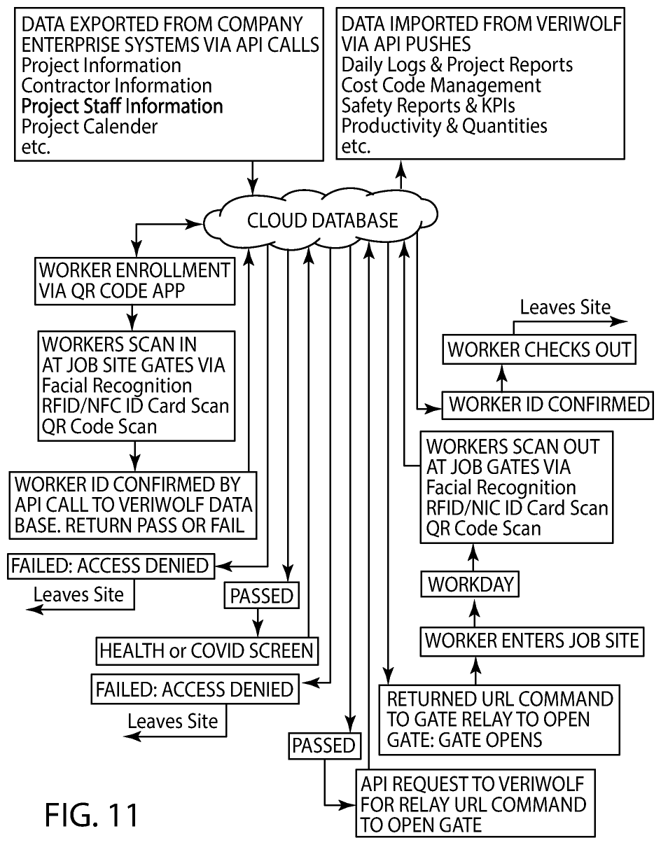

The method can perform the following:
Worker Enrollment. Site-Specific QR Codes can be provided which direct authorized workers and others to a simple enrollment App. A person can input personal data, training, certification, enlist in Contractor Safety Job Site Induction Training, assign ID Cards and photos to become an authorized worker. All data can be pushed to enterprise systems like PROCORE and CMiC for real-time access and retrieval.
Site Access Controls. When present, the app's access control systems control active turnstiles or existing controlled access doors, gates, or barriers. Stand-alone kiosks and wall-mounted control units for indoor and outdoor applications may also be provided.
Manpower & Personnel Tracking. The method advantageously automates manual data entry into required daily reports, i.e., Daily Construction Reports (DCRs), Pre-Task Plans, Job Hazard Analysis, Time Logs, and many Productivity Reports. All data is automatically pushed to enterprise systems like PROCORE and CMiC for real-time access and retrieval.
Cost Codes. In accordance with a highly advantageous element, the method disclosed herein allows selected parties to track cost codes and related work tasks or packages. Quantities of material installed to keep field teams informed and on track may be readily accessed in a report and automatically sent within alert messages. Advantageously the method can auto-populate an enterprise system's field productivity application, that is, the cost codes may be used to correlate with authorized worker inputs such as time of tasks, credentials, worker level showing work done on a construction site, and this information may be presented in real-time.
Safety Reports. The method disclosed herein tracks authorized workers training and certifications and those who have completed Site Safety Orientations and Inductions. Typically, safety training is required for authorized workers, and this method can track completion of the safety training, and present this data in reports, including reports to enterprise systems (like PROCORE and CmiC) for real-time access and retrieval.
Health (Temp/PPE Scanning). The method discloser herein can track and associate gate scans, locations, and health pass/fails of authorized workers and others, identifying those who failed to pass entrance rules and where this failure occurred. Alerts can be sent immediately to staff notifying them of a failed scan or other requirements.
Inspections. The method disclosed herein can create customized inspection protocols and reports based upon the work performed and the selected cost codes. Furthermore, a talk-to-text module may be provided which allows easy to use oral reporting to inspections and uploads content from a phone to generate a report at enterprise systems like PROCORE and CMiC.
Equipment and Materials Deliveries (Import) & Export Reports including Dumpsters. The method disclosed herein can track imports and exports of materials, wastewater, and debris, as well as equipment entering and exiting construction job sites. Selected parties can now track tickets and input quantities or units of materials.
Photo Logs. The method disclosed here allows site staff to take photos and talk-to-text related notes and send push such data to safety and daily log reports, to others, including subcontractors, for example, and to enterprise systems for real-time access and retrieval.
Project Calendar (w/Cost Codes), 2-Week Look-Ahead, & Block-Time Schedular. Project calendars, block-times, and schedules can be viewed and updated in real-time. Reports can be formatted in many different ways, depending on the need of the selected party.
Delays. Delay information about the construction site may be inputted via Talk-to-Text, or from phones/tablets from in the field in real-time, while automatically sending a text or email alert and delivering this information directly into to enterprise systems.
Site Mobility Management. The method disclosed herein can also provide authorized users/selected parties access to all managed data and access control systems to any job site from anywhere in the world.
FIG. 11 shows how data can be pulled from authorized workers, pushed to authorized workers, and pushed to selected parties all through a cloud database which can regularly be updated when a change in status of the construction site occurs.

Daily Automated Project Setup. Cost codes and other relevant data about a construction site may be pulled or called to job site via APIs from the company enterprise system to the system. The data metrics pulled or called by the second, hour, and/or daily can be, for example:
Data called from Project Data source: Project Name, Project ID, Project Address, General Contractor, Specific Locations within the Job site, all approved Contractors' profiles, All Contractors' Project Managers, Supervisor profiles, Worker Profiles, Current Date, Weather Conditions, and Work Descriptions.
Data called from Project Calendar source: Work Package or Tasks, Date & Time of Scheduled Work Package or Task, Contractor associated with each Scheduled Work Package or Task, Cost Code(s) associated with each Scheduled Work Package or Task.
Data called from 2-Week Look-Aheads: Work Package or Task, Date & Time of Scheduled Work Package or Task, Contractor associated with each Scheduled Work Package or Task, Cost Code(s) associated with each Scheduled Work Package or Task.
Data called from Block-Time Schedular source: Date & Start and End Time of Scheduled Delivery (Import) or Export of Equipment or Materials, Crane Times, forklift Times, or lifting apparatus (Equipment) times to move Equipment or Materials for each Block-Time event, Contractor associated with each Block-Time event, Cost Code(s) associated with each Block-Time Event.

Other data which can be pulled to the authorized workers/system administrators will be readily apparent to those skilled in the art given the benefit of this disclosure.

Pre-task plans have traditionally been a daily documents or safety report that an authorized worker may complete on a daily basis before work on a specific task can commence. The authorized worker will inform the owner and contractor, via the Pre-Task Plan, of the desired work or task to be performed and appropriate safety measures, plans, and know hazards pertaining to the task. Traditionally, upon completing the Pre-Task Plan, the authorized worker will have meetings with other authorized workers regarding the content on the Pre-Task Plan prior to starting the work to be performed at the construction site. Depending on the day, construction site work and tasks at hand can determine the amount of pre-task plans and meetings that are needed. Historically this can be just one a day. Pre-task plans help with overall site safety, defining the scope of work, analyze the hazards, develop and implementing hazard controls, identify work to be performed within such hazard controls, and provide feedback and potentially suggest opportunities for continuous improvement. Also, workers are typically required to sign off on their portion of the pre-task plan. In accordance with a highly advantageous aspect, the pre-task plan has been automated and a portion of the pre-task plan the authorized worker is responsible for may be presented to the authorized worker on a mobile device for confirmation, as discussed in greater detail below.

Construction cost codes are understood herein to refer to standardized values and task identifiers (typically numerical) that help contractors and other construction professionals organize expenses into common categories. Sometimes a construction cost codes list provided by the standards organization such as the Construction Specifications Institute (CSI) is used to help ensure documents can be easily interpreted and defined by outside sources (i.e., fellow contractors). However, custom cost codes may be used for construction projects if the contractor believes the CST's list is unsuitable. Standard construction cost code lists help contractors figure out which activities are necessary as well as profitable. The module disclosed herein is particularly valuable for general contractors by helping them materially reduce the amount of time needed to collect required and necessary data/information from subcontractors by transferring inputs and other useful data into enterprise resource management systems which contractors often use (but require tedious manual inputs). Moreover, use of this module opens the door to increased investment in productive areas since the system provides concrete information with which to make capital allocation decisions.

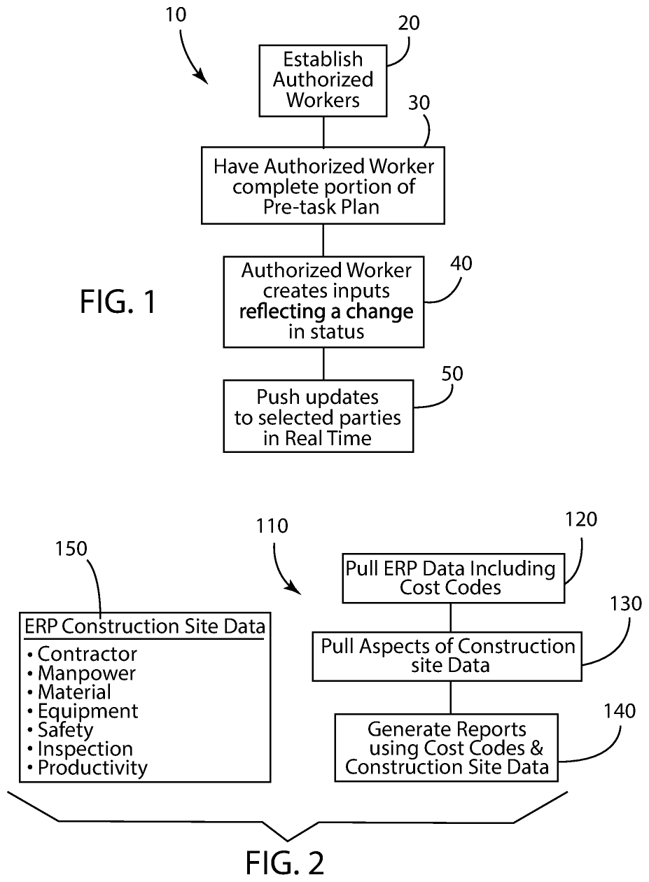

Turning now to the drawings, FIG. 1 shows schematic flow chart of a method 10 for presenting data about a construction sire of a network of operatively connected computers. At step 20, authorized workers are established. These can be workers who have been identified to the network (such as by contractors and sub-contractors) and uploaded into the system. A person may arrive at the construction site ready to perform a portion of work identified in the pre-task plan. Prior to entry into the construction site, typically the person using the method disclosed herein would use an application (app) on his computer (tablet, smart phone, laptop, etc.) operatively connected to other computers on the cloud network via the app, and log into the network, often at a gate or other entry points at the construction site. The person would enter inputs into the system (at least the person's name), and the input would be compared with a reference database of authorized workers to allow the person to identify himself to the network. Optionally a drop-down menu may be sent to the person, showing a list of authorized workers and allowing for the person to select his name merely by tapping a touchscreen at the appropriate location. Alternatively, voice recognition may be used. An important feature of the method disclosed herein is ease of use for the authorized workers, to help ensure compliance (which in turn enhances safety and allows for more efficient management of what is inherently a complex and potentially dangerous endeavor). Additional security, such as face recognition or other passcodes may also be required for the person to establish himself as an authorized worker. Permission to enter may also extend to guests. When a guest presents himself, an administrator and/or site manager may be prompted on his computer (smart phone, tablet, laptop, etc.) for approval to allow the person to enter as a guest. Guests who have computers or mobile devices with them (understood here to be most likely a smart phone) can download the application on their phone and log into the system for approval. The screens presented to guests can be simpler than the screens presented to authorized workers.

Beyond additional security, to complete the process of establishing the person as an authorized worker, health screening may be required (such as a check of temperature or questionnaire), and a safety screen as part of the creation of a daily safety report. During the daily Check in/Out process, a daily safety report or Pre-Task Plan must typically be completed before commencing work that day. The safety screen is part of the pre-task plan, can comprise, for example, a message or list of questions sent to the person's mobile device or a video. The pre-task plan may include many questions for authorized workers but will only push a subset of the list of questions which are specific to the authorized worker's task or work package as part of the process of presenting to confirm the person is an authorized worker. After viewing the subset of questions/message/video, the person would have to acknowledge viewing the safety training (again, this can be done by touch screen confirmation or by voice confirmation). Only after confirmation would the person be considered an authorized worker permitted to enter the construction site. Often this safety screen is required every time an authorized worker enters a construction site.

At step 30 the authorized worker completes a portion of the pre-task plan. After initial approvals, the authorized worker can be presented with a daily work schedule of that authorized worker. The daily work schedule is a subset of the work to be done on the construction site for a given day for a given authorized worker. The authorized workers are those persons who are supposed to be on the construction site. The construction site may have many workers, and the system can push the portion of the pre-task plan with the daily work schedule specific for each authorized worker. As the worker completes the tasks assigned him (or at least before he exits the construction site for the day), the worker can create inputs (step 40) corresponding generally to a change in status. Typically, the change in status is the completion of a task, but a change in status can also be the inputs generated by the authorized worker corresponding to the change in status comprises one or more of acknowledging the portion of the pre-task plan relating to the authorized worker, presenting information about a status of at least one of equipment, materials, and authorized workers, presenting information about safety, presenting information about an inspection, or presenting information about other unexpected or unanticipated events. The authorized worker makes selections for input using the touchscreen on his mobile device (which is operatively connected to the rest of the computers on the network), by using a drop-down menu, for example. Other techniques for making inputs can comprise voice data (through voice recognition software), talk-to-text data, pictorial data and video data. Also the information may be displayed to tablet of the person in the form of Yes/No questions for the person to answer. Reports such as alerts (such as for lack of attendance by an expected authorized worker) and error messages can be pushed to system administrators and/or site foreman for example when problems occur. Examples of these alerts are discussed in greater detail below.

The system uses the authorized worker inputs in combination with data pulled from an enterprise resource planning modules which the system is preferably operatively connected to. Such enterprise resource planning data can comprise, for example one or more cost codes. The one or more cost codes are presented to the authorized worker on one of a tablet, smartphone and laptop operatively connected to the network and can optionally use a drop-down menu. Generally pre-populated forms, and interlinked forms, where the same data used in one form is populated in another form with the same data, can be used. The authorized worker makes his selections and these act as inputs which automatically correspond to costs codes. In accordance with a highly advantageous element, a report (which includes alerts, updates, and error messages) can be created in real-time and pushed to selected parties. Step 50. The selected parties can comprise an agent of a general contractor, an agent of a subcontractor, the authorized worker who completed the pre-task plan (messages can be sent to the authorized worker to temporarily delay work, for example), and other authorized workers who can be near the authorized worker who completed the pre-task plan (which can be useful when tasks need to performed sequentially and one authorized worker cannot begin his task until another authorized worker completes his task), and system administrators and those deemed as a selected party by the system administrator. For example, selected parties could include guests or regulatory agencies. In this manner the method disclosed herein advantageously helps to prevent small problems from becoming large problems. Real-time is understood herein to mean the very short amount of time needed to transmit data from one computer or mobile device on the interconnected network to another. Such real-time data may also be stored for generation of reports over longer periods of time, from daily reports to various tracking metrics.

FIG. 2 shows another aspect of the method 110 disclosed herein for presenting data about a construction site to a network of operatively connected computers or mobile devices. At step 120, enterprise resource planning data is pulled from an enterprise resource planning module (such as ProCore or Cmic), wherein the enterprise resource planning data comprise one or more cost codes. As noted above, the cost codes are the defined list of codes that are used for tracking, managing, reporting on the amounts, quantities, budgets, profit and other account information associated with the job for a given construction site. At step 130 aspects of the construction site are also pulled. These aspects relate broadly to one or more types of information about the construction site, and can comprise, for example, information about at least one of manpower, contractors, materials, equipment, productivity, safety, and inspection. Table 150. The information may also pertain to environmental data, such as storms, for example. At step 140, a report is generated about at least one aspect of the data/information of the construction site, wherein the completed report also comprises the one or more cost codes. Preferably the cost codes used in the report correlate with at least one of the aspects of information about the construction site. The report about the at least one aspect of the construction site data, with cost codes, may be pushed to one or more selected parties (with the selected parties having the same meaning as above). Optionally the reports may be generated in real-time.

The manpower information can comprise any of a status of any person on the construction site, an illness of any authorized worker, and expected output of any authorized worker, an actual output of any authorized worker. The manpower information can also comprise time logs which can be tracked against a cost code specific to that work and tracked over time. The materials information can comprise materials entering and/or exiting the construction site, along with a status of materials on the site (such as when materials are damaged, wasted, used up, or lost). In a similar manner, the equipment information can comprise at least one of equipment entering the construction site, equipment exiting the construction site, and an equipment status at the construction site (has the equipment been damaged, for example).

Advantageously, the report can track an aspect (of the construction site data) over time against a cost code. This contrasts dramatically with existing report generation techniques, which are slow, inaccurate, and often do not reflect reality. Examples of such productivity reports comprise both material and equipment inputs, actual vs. forecast, authorized worker outputs—actual vs. forecast, and a health status of authorized workers. Advantageously, such reports allow the system administrator to much more efficiently collect historic production rates and/or worker status to make recommendations about upcoming work to be done. The reports generated can also comprise at least one of a daily report, a notification of delay, and a notification of a failure to complete a required report (such as regulatory, inspections and/or required safety reports), other manpower tracking such as health screening, safety training based on the PTP, a report for tomorrow's work (which may be changed by the administrator in response to inputs from the authorized workers), a project calendar, a safety protocol (based on authorized worker status or other conditions at the job site), any amendments to a scheduled calendar based on inputs received (which could include inspections or other delays), PTPs, a list of authorized workers not showing up, a list of broken equipment or unavailable materials or other items which generate delays, a daily log data, a log of real-time inputs such as the arrival of worker/guests/materials/equipment. For these kinds of changes in status an alert may be sent to an agent (such as the foreman) and to central control (System Administrator and/or general contractor, for example. These notifications may be made to computers or mobile devices on the network remote from the job site).

In accordance with another highly advantageous feature which makes the method easier for authorized workers to use, a schematic of a portion of the construction site can be presented to a computer or mobile device of an authorized worker, and the authorized worker can indicate daily work completed pictorially. This can be accomplished merely by touching a touch screen inputting where the authorized worker completed work that day. Such ease of use also provides for pictorial representation of progress on the work at the construction site.

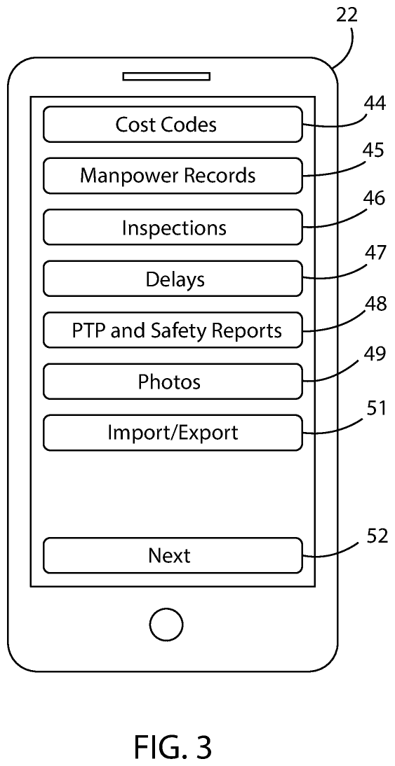

FIG. 3 represents an example of the kind of screen on the app pushed to persons on their smartphone 22. A touchscreen may be used, and tabs can be presented for cost codes 44 (to indicate the type of work an authorized worker will be performing that day), time records 45 (to indicate amount of time to complete the work), inspections 46 (to indicate results of inspections and/or schedule of inspections), delays 47, safety violations/accidents 48, photos 49 (which can include other attachments, such as pdf files), import/export 51 and a next button/tab 52. Other ways of presentation will be readily apparent to those skilled in the art given the benefit of this disclosure.

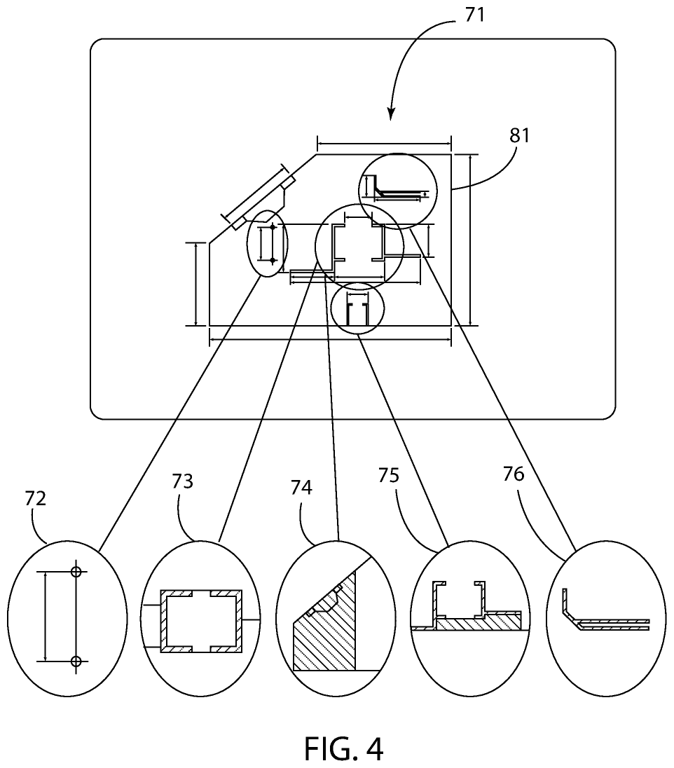

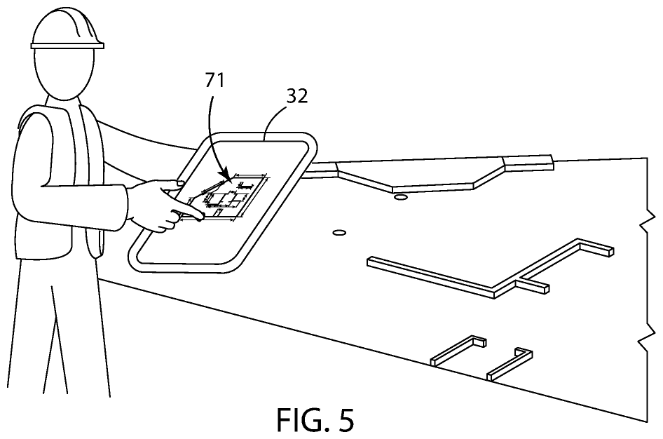

FIG. 4 shows a schematic of a portion of the construction site, here, the portion is a floor plan 81 for one floor of a building. The floor plan may optionally be presented on a screen of a computer (such as a mobile device of an authorized worker) of the network. The floor plans can comprise blueprints, architectural, and engineering drawings pulled from architectural CAD type software, for example, including sub-categories of the architectural drawings such as materials lists and quantities. Pulling the materials quantity data is also highly advantageous since it allows the system to know how much materials were installed and how much may be are needed going forward based on use made the previous day. This method will automatically calculate materials used and materials needed as tasks are being performed and will present to the authorized workers a real-time comparative list of materials used and needed to complete the tasks. The authorized worker may select which type architectural drawing and location that represents the work or task performed. The authorized worker can then select a specific portion of the selected drawing and indicate competed work and materials used and needed by simply using his finger and touching the areas of the drawing where work is performed. Various components of the floor plan may be presented schematically as well and may be expanded for enhanced viewing. The examples in FIG. 4 include structural columns 72, concrete shear walls 73, a concrete slab 74, other concrete 75 and concrete walls 76. Other components of the floor plan which can be displayed will be readily apparent to those skilled in the art given the benefit of this disclosure.

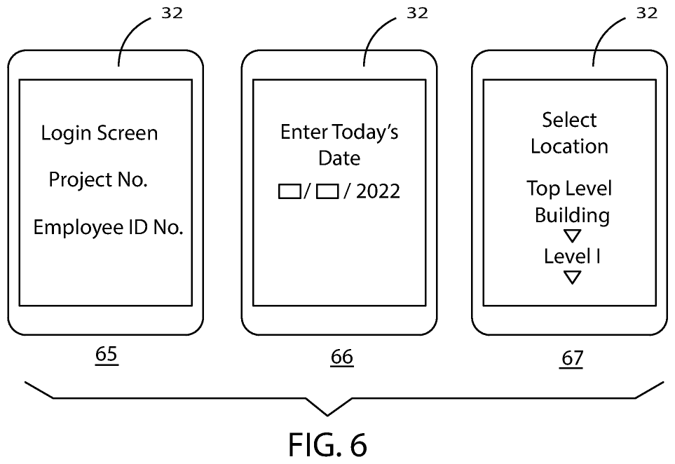

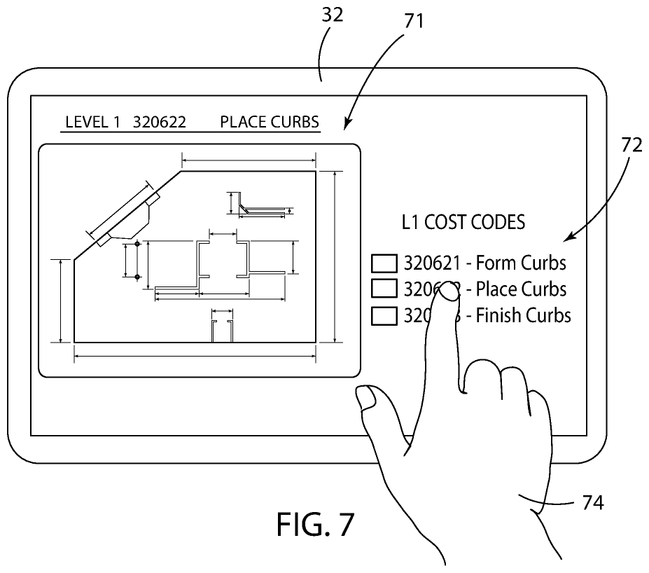

FIG. 5 is a schematic of an authorized worker using a tablet 32 to enter inputs corresponding to changes in status of data at the construction site, showing a schematic of at least a portion of the construction site represented on a screen of the tablet 32, here the floor plan 71. FIG. 6 shows a series of screens presented to the authorized worker to allow him to input his work done for the day. After completing a login screen 65, the authorized worker may be presented with a request to indicate today's date 66, and then to select a location, such as a particular level of a building 67 (and can scroll to the particular floor). Once that is complete, FIG. 7 shows that a schematic 71 of the floor selected (here, Level 1) is presented on the tablet 32, and a series of cost codes may be presented. The authorized worker in this case has selected 320622, which corresponds to placing curbs (and should correspond to the work the authorized worker performed that day). The system may place the cost code selected and the type of work to be done on the screen as shown, to help confirm to the authorized worker that he has selected the correct cost code.

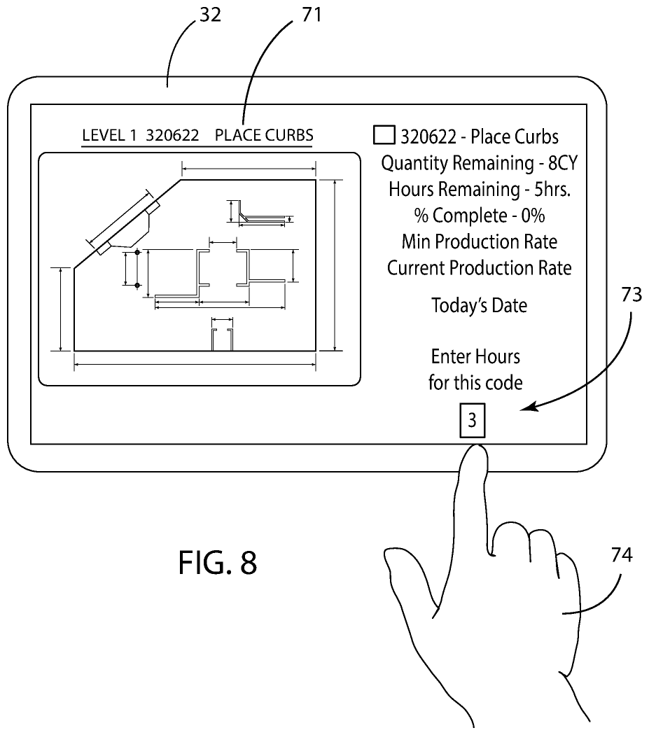

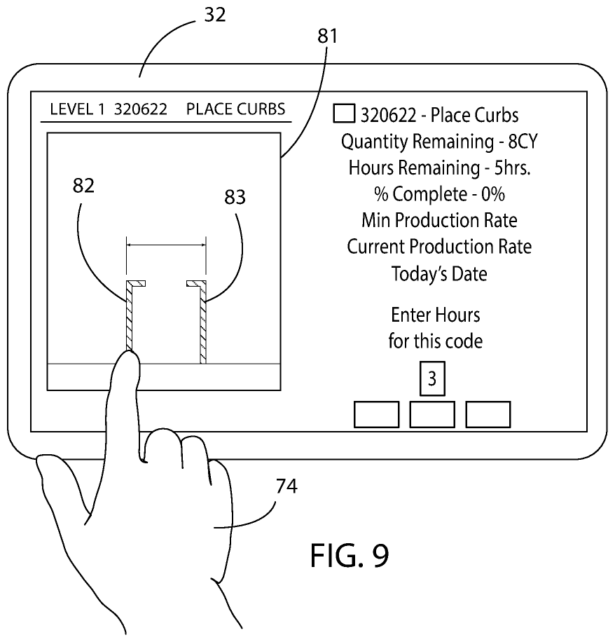

FIG. 8 shows another screen where after the authorized worker has selected his cost code, a request for time may appear. The authorized worker 74 can optionally swipe through units of time 73 to select the amount of time he spent working on the project (here 3 hours). In accordance with another advantageous element, the authorized worker can merely touch a portion of the screen of the tablet (the touchscreen) to indicate completion of a task/daily work, or a percentage (%) of the task that is completed and/or materials used. For example, in FIG. 9, once the authorized worker has selected the correct cost code (place curbs) and the amount of time (3 hours), a display of curbs on the schematic of the floor may be presented, and the authorized worker can select the curbs 82, 83 which he actually placed that day, optionally by use of touching a touchscreen or by some other coloring tool, and confirming the selection by seeing a change in shading on the curbs 82, 83. This allows for pictorial representation of progress made at the construction site.

Metrics for Reports. With the collection of useful data collected by the methods disclosed herein, many different aspects of construction site data can be collected and presented, in one of several different ways. The following paragraphs list several variations. Other variations for presentation of metrics for report will be readily apparent to those skilled in the art given the benefit of this disclosure. Reports may be generated and presented internally to an administrator, or to customers and regulatory agencies, or to contractors and sub-contractors, or to authorized workers or others as needed. For example, a daily safety report can be used for each trade contractor to inform the general contractor or owner of the work tasks or packages to be perform that specific day, the safety measures employed to perform the work, and the work plan, by that trade contractor. This document is one of the only times in which a general contractor has the eyes and the attention of the trade contractor's crew leads (Forman) on a required report that must be filed. Reports may be presented in one of many different ways, including dashboards which are accessible on a screen of a computer or mobile device operatively connected to the network of computers. Preferably navigation between reports can be relatively flat with a header frame allowing pulldown links to each section and sub-section from any other page on the site. The main sections can comprise 1. dashboard, 2. information about one or more sites, 3. information about contractors, 4. workers, 5. reports, 6. administration, 7. system developer administration, and 8. a person currently authorized to be logged into the system developer administration.

1. Dashboard. A dashboard presentation of a report can show, for example, a list of all workers currently onsite at a given jobsite. The dashboard may have a site filter, which is a pulldown menu which allows a user to toggle between multiple active jobsites. The dashboard may be provided with customizable column headers that allow the user to search among the active workers currently onsite at the chosen jobsite. The possible searchable fields can be identification, name, contractor, supervisor, trade group, trade, worker level, competent person or authorized worker, check-in time, hours onsite, supervisor contact, emergency contact, emergency contact number and gender. System administrators, owners, contractors and project managers may be preferred selected parties to view the dashboard report.

2. Sites. Reports about sites can be provided with sections for searching construction sites, adding a site, and viewing/editing a site. For the section pertaining to searching sites, a list of construction sites that have been created may be shown. Other columns on this construction site page can be for site ID, name, description, a job name, a job number, city, state, active (yes/no), a filter field which allows a user to type in text to filter through the contents of any of the above fields, a pull-down menu which allows the user to sort by site ID, by name, by job name, by job number, or by city.

The name of each site can also be a navigation link to the sites optionally in the viewing/editing site section. In this section a series of tabs may be provided, and users can view or edit data associated with a given existing jobsite. Tabs within this section can be: a basic tab, contractor tab, scanning locations tab, configuration tab, and create a site tab. Each of these tabs of the viewing/editing section are discussed in turn below.

The basic tab of the sites column can contain the following fields: site ID a number that can be assigned when the system creates a new site; site name*—specified by user; a description which can be specified by a user; a competent person ratio which can be specified by the user, of Competent Persons (a certified person to run safety training for a specific project) to workers that are not considered Competent Persons; a journeyman apprentice ratio, which can be specified by user as a ratio of journeymen to apprentices that must be maintained on the jobsite; an identification scan, which is a pulldown menu allowing user to choose from a barcode scan, manual entry, iris recognition, facial recognition, thumb print, RFID, QR Code; active—Yes/No toggle; and an address subsection.

The contractor tab—in the edit mode, the user can pick contractors from the list of existing contractors (see Contractors main section discussed below to create or edit these) or can display the following columns in viewing mode: ID, where the system assigns a unique number for this contractor when a contractor is created (within the Contractors top-level section); and trade group.

The scanning locations tab—a Location subsection of this page allows user to add a job site by filling in the following fields then clicking an Add Location button: location name; description; scan type, a pulldown menu allowing a user to choose from a time scan, a location scan, an ID Scan; direction a pulldown menu allowing user to choose from: In/Out; device type; device ID; device name. The list of location subsections on this page can show the following columns for already existing locations: name, description, scan type, direction, device type, device ID, device name and action—which shows a Remove button to enable deletion of existing site. Additional items present in the scanning locations tab can comprise a filter field which allows a user to search the content of the above columns, and a pulldown menu which can also allow sorting by create date, name, scan type, direction, device type and device name.

Configuration tab—This tab of the site's column allows a user to set up go/no go rules for the specific job site when workers are scanned allowing or disallowing site access. For example, an On/Off toggle for these four rules may be provided: trade certification, orientation training, safety certification, and safety training, each or all as part of Active Worker Go & No Go Check.

Create a Site tab can contain the following input fields: a site ID, which is a number that is assigned when the system creates a new Site, a site name, a description specified by the user, a competent person ratio, a journeyman apprentice ratio, an identification scan—which can be a pulldown menu allowing user to choose from several different techniques for active worker identification, such as barcode scan, manual entry, iris recognition, facial recognition, thumb print, RFID, and QR Code. Additional input fields for the Create a Site tab may comprise, an active—Yes/No toggle, and an address. In the system disclosed herein security is greatly enhanced by the use of the methods disclosed, not only in the security and identification measures adopted for authorized workers, but also in that real-time data about who is at the construction site may advantageously be provided to the system administrator, and to any selected parties selected by the system administrator.

3. Contractors. The next main section, contractors, may have sections for search contractor, view/edit contractor, new contractor and bulk changes. Search contractors can show a list of contractors that have already been created. Columns on this page/section can comprise, contractor ID, name, contact name, contact number, URL, address, and active (yes/no). Also, a filter field can be provided to allow the user to type in text to filter thorough the contents of any of the above fields. A pull-down menu may also be provided to allow the user to sort by company ID, company name, contact or contractor. The name of each contractor can also be a navigation link to the Contractors/View/Edit Contractor section. Here users can view or edit data associated with a given existing contractor. Tabs within this section can be: Basic Tab, Insurance Bond and License tab, a crew selection tab, and attachments tab.

The basic tab can contain the following fields company ID, name, a diversity supplier, which can be a pulldown menu allowing user to choose one of the following categories: minority contractors and suppliers, disabled owned, woman owned, veteran owned contractors and suppliers. The basic tab can also have an active—Yes/No toggle switch, a trade group which can allow a user to choose one or more of the following: Check All, Uncheck All, General Requirements, Site Construction, Concrete, masonry, metals, wood/plastic, thermal & moisture protection, doors/windows, finishes, specialties, equipment, furnishings, special construction, conveying systems, plumbing and mechanical, and electrical, and a URL. The basic tab may also have contact information for the contractor, alternate contact information, an experience modification (EMR) rating, a primary address and a mailing address.

The insurance, bond & license tab can provide recordation of important information about the contractors, and can comprise a license subsection, an insurance subsection, a registration subsection, and a bond subsection, each subsection with details sufficient to identify the requisite insurance bond or license.

The crew selection tab can provide recordation of authorized workers for each contractor, and can comprise a site, which can be a pulldown menu allowing user to pick from any existing work site, a list of workers, which can be a searchable field to allow search through all existing workers, and a user can just click on the worker's name underneath to add it to the crew list. Any number of workers can then be added to the Crew List; a Crew Supervisor; and an Add Crew feature. This Crew will then show below in the List of Crew subsection with: columns indicating the Site, Name, and members for each crew, a Remove button allowing the deletion of this crew, and a print button allows the printing of barcodes for the entire crew in a single batch. The users can also print barcodes for an individual worker in the workers section of the site.

Attachments Tab—which can be used to upload one or more of many types of attachments and can comprise an upload attachments subsection, and a list of attachments subsection—each attachment shows as a line on a list.

New Contractor—The section under Contractors for New Contractor can comprise inputs to create a new Contractor and include one or more of the following fields: company ID, name, diversity supplier, active*—Yes/No toggle switch, trade group, a URL, contact information, alternate contact information, an EMR rating, a primary address and a mailing address.

Bulk Changes—The section under Contractors for bulk changes allows for bulk changes using an uploaded file. The user can be prompted to browse for a file to upload, such as an Excel file (or another spreadsheet).

4. Workers—similar to the contractor section, the workers section has subsections for search workers, view/edit workers, new workers and bulk changes. The search workers section can show a list of workers that have already been created, that is, authorized workers. As before, the name of each worker can also be a navigation link to the View/Edit worker section. Here users can view or edit data associated with a given existing worker. Tabs within this section are: a basic tab, an event history tab, a training tab, a certification tab, a noncompliance tab, an incidents tab, an employment information tab, a drug test tab and an attachments tab.

Basic tab. The basic tab may have a relatively large set of information about the each authorized worker, such as a name, a photo of the worker (with use camera and upload picture buttons), a SSN, a date of birth, gender, ethnicity, a system ID, whether the worker is employing subcontractors (a pull-down menu may be provided allowing a user to select any established contractor), a sub-contractor employer ID, a trade group, a trade, a worker level (foreman, journeyman, apprentice, etc.), competent person—preferably with a Yes/No toggle, active*—also preferably formatted as a yes/no toggle, an emergency contact subsection, a barcode, a supervisor name, a supervisor contact, a contact information subsection and an address subsection.

Event History tab—This tab can show a record of all inputs/scans for this authorized worker. As with the other tabs, real-time reports may be generated using information collected here. Data in column format can include: site, date/time, event name, and location. A filter field can be provided to allow the user to type in text to filter thorough the contents of any of the above columns. This can include, for example, pull-down menus to sort by time, place, location and/or event name.

Training tab—This tab can show training records. The training tab can comprise a training subsection, an approved training for sites, and a list of training. Fields can comprise the construction site (where the authorized worker is working), a title, an instructor, an effective date, training attachments (which can be a pull-down menu allowing the user to choose to associate a particular training with a particular attachment previously uploaded through the attachments tab), and an add training feature.

Certification Tab—Similar to the training tab, this tab can provide data about a worker's necessary certifications. Representative subsections can comprise add certification, approve certifications for sites, and list of certifications. This information may be presented in columns and the user may search using a filter field with a pull-down menu in a manner like the other pull-down menus.

Noncompliance Tab—a noncompliance tab can provide data about noncompliance by authorized workers and contractors. Representative subsections can comprise add noncompliance (optionally with attachments) and approve noncompliance for site (which can list all existing construction sites with checkboxes next to each to allow the user to separately associate a noncompliance with a particular construction site). This information may be presented in columns and the user may search using a filter field with a pull-down menu in a manner similar to the other pull-down menus.

Incidents Tab—an incidents tab can provide data about incidents such as violations or accidents. Representative subsections can comprise add incident (as with the certification tab or noncompliance tab, etc., optionally with attachments), and approve incidents for site (which can list all existing construction sites with checkboxes next to each to allow the user to separately associate an incident with a particular construction site). This information may be presented in columns and the user may search using a filter field with a pull-down menu in a manner similar to the other pull-down menus.

Employment Information Tab—This tab can provide information about authorized workers and have the following fields: approve with Yes/No toggle, job type, tools used, driver's license, passport, green card, visa and sex offender status.

Drug Test tab—This tab can provide information about whether authorized workers have passed a drug test and have the following fields: approve with Yes/No toggle, add test, and a list of tests subsection. Information may be presented and accessed in a manner similar to the other tabs.

Attachments tab—As attachments may be relatively bulky pdf or jpeg files (in some circumstances), a separate tab may be provided for attachments may be provided. The attachments tab may have an upload attachments subsection, and a list of attachments subsection. Information may be presented and accessed in a manner similar to the other tabs.

5. Reports section—The reports section can comprise a daily construction report, advantageously allowing management and other selected parties to follow progress at the construction site each day. Such daily timing may be sufficient for acceptable management of a construction site. The option of real-time alerts and reports may be handled separately. The reports section can comprise information about the site, the contractors, a daily work description, a list of events and/or issues, and be provided with the ability to edit the report after it is created, and a generate report button on a screen, typically on the screen of a computer of the administrator (or another computer otherwise approved by the administrator). Other reports may be generated or stored, including timecards, and time keeping in general, and pre-task plans.

6. Administration section—includes Search Users, Add User and New User subsections. The search user's subsection lists users of the application that have already been created and would include authorized workers and approved contractors. This information may be presented in columns and the user may search using a filter field with a pull-down menu in a manner like the other pull-down menus.

7. System Administrator—This section can comprise check in/out worker and event log subsections. The check in/out authorized worker subsection allows the user to look up an authorized worker to manually check in or check out that authorized worker, that is, the system administrator can have an override function for authorized workers. This can be done, for example by including information about a system ID, the construction site, providing a Get Worker button to access the authorized worker to manually check in or out. Preferably both the system ID and Site should be the same to access the appropriate record. An event log may also be provided, which allows the user to access inputs by individual authorized workers. This information may be presented in columns and the user may search using a filter field with a pull-down menu in a manner like the other pull-down menus.

8. System Administrator Username/Password—This section allows for the system administrator (or other appropriately assigned user or agent of the system administrator) to change usernames and passwords. Optionally the system administrator can immediately log out the authorized worker. This information may be presented in columns and the user may search using a filter field with a pull-down menu in a manner similar to the other pull-down menus.

Set-Up and Job Site ID Scanning. Listed below are examples of authorized worker set-ups and permissions, as well as job site ID scanning set-up and permissions. Other examples of set-up and job site ID scanning will be readily apparent to those skilled in the art, given the benefit of this disclosure. Persons, including both authorized workers and guests, can use their own mobile devices, laptops, or tablets as an NFC ID card or Facial recognition ID to activate an access control system for job site entry. Persons can also use third party Biometric Scanners and/or RFID/NFC ID Card scanning devices located at predetermined ingress/egress points on construction job sites like gates, door, turnstiles, or QR Code postings for job site entry. QR Code scans on the person's device can enable the person to run or download an application (app) remotely but be connected to the network of other computers. Each onsite scanning device and QR Code can be assigned a location at an enterprise level. These locations can be used to locate authorized workers entering and leaving active job sites through specific ingress/egress points or specific areas within or about the job site that require additional oversight.

QR Code Worker Enrollment & QR Code Check In/Out. When a person opens the app (such as via QR Code), the person sees a splash screen from which the app can open a mobile or PC App version (dependent upon the accessing device). Once opened, the App can direct the person to a secured login page displaying the Job Site name and Location (Ex. Front Gate, Loading Dock, etc.). The person can then be prompted to select his Employer/Contactor from a dropdown menu created via an API call to the Company Enterprise system requesting Contractor Information. The person can then be prompted to select his name from a dropdown menu created via an API call to the Company Enterprise system requesting Worker Information or directly from an authorized worker table or list. The person can then be prompted to enter their Helmet Sticker Number or Secret Code for secondary ID authentication. Once the person is established as an authorized worker (or a Guest), the authorized worker can optionally then be prompted to answer questions from a health screening page where health related questions can be presented.

Health Screening Menu. The following describes how an authorized person can navigate a health screening menu. The person has downloaded an app onto his computer which makes his computer operatively connected to the network (which typically includes a cloud database). If the authorized worker selects “NO” to Health-related exposure (e.g., COVID-19, flu, etc.) in the health screening menu, a signature block screen may be presented to the authorized worker's device which states a disclaimer or other suitable message and a box wherein the authorized worker signs the screen with his finger, stylus, or mouse, accepting the terms of the disclaimer. Once signed, a check-in/sign-In button can be presented for the authorized worker to push or touch to officially check into the job site. When the check-in button is touched, the authorized worker can see a splash screen indicating access is granted. If the job site has gates, turnstiles, or other physical obstructions controlled by the system, the gates et al locking devices can release via a URL command and allow the authorized worker to pass through and into the job site. If the person selects “YES” on the health exposure page, the gates can remain locked, and the screen can present with markings and words warning the person that job site entry is “DENIED” and to wait outside the job site for further instruction by authorized Site Supervisors. In addition, an SMS or text message may be sent to pre-assigned Site Supervisors stating that the Person is at the Job Site entrance waiting for further instruction. The person's name, +1 added to Authorized Worker Headcount, Contractor Name, Health Exposure answers, and Check-In time can be recorded and advantageously pushed to company enterprise systems in real-time.

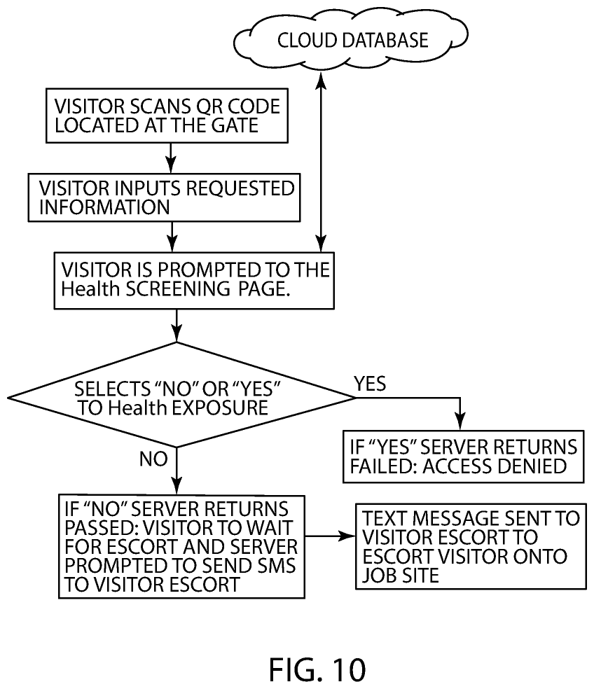

Visitor Check-in. Visitor check-in is a substantially similar process, and an example is shown in FIG. 10. When a visitor opens the app (such as via a QR Code scan at a gate of the construction site), a splash screen is presented from which the App can open a mobile or PC App version (dependent upon accessing device). Once opened, the App can direct the person to a secured login page displaying the Job Site name and Location (Ex. Front Gate, Loading Dock, etc.). The visitor can then be prompted to input the requested information, such as to select the Employer/Contactor to be visited from a dropdown menu/list created via an API call to the company enterprise system requesting contractor information. The visitor can then be prompted to enter his name and select the “Next” button and then be prompted to answer questions from the health screening page. At the health screening menu, if the visitor selects “NO” to health questions (such as no exposure to a virus, or otherwise passes the screening), the visitor is deemed to have passed, a signature block screen is presented wherein the visitor signs the screen with his finger, stylus, or mouse. Once signed, the visitor can select the “Save Signature” button, thereby becoming a guest at the construction site. The visitor can then select the request permission to enter the job site button and be prompted to wait for a Site Escort to escort him/her on to the job site. An SMS or text message can be sent to an approved Guest/Visitor Escort that a guest is waiting to enter the job site. Optionally the job site has gates, turnstiles, or other physical obstructions controlled by the system's access control systems (ACS) as before, and in this case the gates can remain locked without the guest escort. If the Visitor selects “YES” to health exposure page, the gates et al. can remain locked, the visitor can see an immediate screen with markings and words warning the Person that Job Site Entry is “DENIED” and to wait outside the job site for further instruction by authorized Site Supervisors. The system can send an SMS or text message to pre-assigned Site Supervisors stating that the Visitor selected “YES” to health screening and is at the Job Site entrance waiting for further instruction. The Guest/Visitor's Name, +1 added to headcount, Visitor Contractor Name, Health Exposure “NO” or “YES” answers, and “Request Entry” time can be recorded and advantageously pushed to the company enterprise system in real-time.

New Worker Enrollment. When a person accesses the app for the first time, they can receive a splash screen from which the app can open a mobile or PC App version (dependent upon accessing device). Once opened, the App can direct the person to a secured login page displaying the job site name and location (for example, the Front Gate, Loading Dock, etc.). The person can then be prompted to select his Employer/Contactor from a dropdown menu/list created via an API call to the company enterprise system requesting contractor information. The person can then be prompted to select his name from a dropdown menu created via an API call to the company enterprise system requesting authorized worker information or directly from an authorized worker tables or list. If the person cannot find their name in the dropdown menu, the person can select an Add New Worker button that directs the person to an enrollment page where the person can enter their first name, last name, and helmet sticker number (if required). As an important advantage of this system is worker safety, all authorized workers must receive significant safety training. Here, prior to becoming an authorized worker, the person can select a complete safety induction or orientation button located adjacent to the helmet sticker number or secret code box. Once selected, the person can be shown a safety induction or orientation presentation in the form of a slide show or video presentation. Once completed, the person can be prompted to select the “Agree & Complete” button. When the person selects the “Agree & Complete” button, an “Acknowledge Statement” with, for example, the person's name already populated within the acknowledgement statement in the form of “I, (Person's Name), acknowledge that I have fully read [the safety document].” The person can check a box indicating that they have read the statement. Once the box is checked, a “You Passed all Safety Induction Requirements” prompt can appear and the person can now select the “complete safety induction or orientation” button on the screen. The person can then be prompted to select his authorized worker level from a predetermined list of Worker Levels such as Journeyman, Apprentice, Forman, etc. The person can then be prompted to select “Training Level” from a predetermined list such as OSHA 10, OSHA 30, CPR Card, etc. Once selected, the person can then be prompted to select “Your Worker Access ID Card” button where, if his job site requires Access ID Cards to scan at a Job site entrance to activate and open locked gates or doors via access control systems (similar to the type discussed above), an access card can be scanned into the Persons profile. Here, the Person can select “Scan Worker Access ID Card” button and can activate the device (Phone, Tablet, Or PC) camera where the Person can place the ID card in view of the device camera and the device can scan the card's barcode printed on the face of the ID Card. This barcode matches the RFIC/NFC ID number encoded within the ID Card. This ID Number can display within the “Your Worker Access ID Card” box and assigned to the authorized worker profile. This ID card number may also be used to activate an NFC function on a phone where the phone becomes an “ID Card” unto itself and can be used in leu of a plastic ID Card to touch a card scanner to activate's Access Control Systems to open gates and turnstiles. (For example, similar to a mobile phone's wallet feature where a person can pay for a coffee by simply touching the phone to a scanner.) The person can then be prompted to “Add Photo” by taking a selfie of themselves, for example. When the person selects the “Add Photo” button, the camera on the mobile device or PC can be activated and a photo can be taken. This photo can be added to the authorized worker profile and optionally be uploaded into a facial recognition application. Once worker enrollment is completed, the person can select the +Create Worker button and be directed to the health screening page. The person can be prompted to answer health exposure related questions in the same manner as discussed above.

Facial Recognition. If a third-party facial recognition scanner is present at the job site entrance, the person can present his face to the scanner where a facial ID, body temperature, and PPE (facial mask) scan can be processed, if required. If a person's ID is not recognized, the person's temperature is unacceptably high, the person can be denied access to the job site and any gate et al, as controlled and set by the ACS, can remain locked. If the scan determines that the person is an authorized worker, authenticated by the photo captured at worker enrollment, and their body temperature is below a predetermined threshold, and the person is otherwise compliant, the gates or turnstiles can be unlocked, allowing the Person to pass through and into the job site. The person's name, +1 added to an authorized worker headcount, contractor name, health exposure answers, and check-in time can be recorded and pushed to Company enterprise systems in real-time.

When a person opens the app, the person receives a splash screen from which the App can open a mobile or PC App version, depending on accessing device. Once opened, the App can direct the person to a secured login page displaying the Job Site name and Location (Ex. Front Gate, Loading Dock, etc.). The Person can then be prompted to scan their face. This photo so generated can then be processed and compared to the person's photo captured at worker enrollment. If a person is not recognized, the person can be denied access to the job site and any gate et al can remain locked. If the scan determines that the person is an authorized worker, the gates or turnstiles can remain locked and a message can be sent to the authorized worker's phone/tablet to the health screening page. If a person is not recognized, the person can be denied access to the job site and any gate et al. can remain locked. If the scan determines that the Person is an authorized Person, then the person can be granted access to the job site and the job site has a gate et al controlled by ACS, the gate et al locking device can be released via a URL command and allow the authorized person to pass through and into the job site. As before, several aspects about the worker may be recorded and pushed to company enterprise systems in real-time.

The person/authorized person can use the ID card number captured at worker enrollment to activate the NFC function on a phone. The phone can now replace an “ID Card” and be used in leu of an ID Card to touch a scanner to activate the ACS to open gates and turnstiles. (Similar to a mobile phone's “Wallet” feature.)

If a third-party RFID/FC ID Card Scanner is present at the job site entrance, the Person can present his ID Card or Persons Phone via's Cardless NFC App assigned at worker enrollment to the scanner to be processed. If a Person ID Card or NFC phone scan is not recognized, the Person can be denied access to the job site and any gate et al. controlled by ACS can remain locked. If the scan determines that the person is an authorized worker, the gates or turnstiles can be unlocked and can send a link via SMS or text message to the Person's phone to the Health Screening Menu. The same health screening menu can be applied to a login via Cardless NFC App Scanning Methods, as described above.

If a third-party RFID/FC ID Card Scanner is present at the job site entrance, the Person can present ID Card or Person's Phone via's Cardless NFC App assigned at Worker Enrollment to the scanner to be processed. If a Person ID Card or Person's Phone via's Cardless NFC App is not recognized, the Person can be denied access to the job site and any gate et al. can remain locked. If the scan determines that the Person is authorized, the Person can be granted access and the gate et al. locking device controlled by ACS, can release via a URL command allowing the Person to pass through and into the job site. The Person Name, +1 added to Worker Headcount, Person Contractor Name, Health or COVID Exposure “NO” or “YES” answers, and “Check-In” time can be recorded into the database and pushed to Company enterprise systems in real-time. The database typically comprises authorized workers who are direct employees or agents of any of the contractors or sub-contractors and would be presented to the system so that their agents can enter the construction site using the method disclosed herein.

End of Shift. When an authorized worker (or potentially a guest) leaves the Job site, the authorized worker can use the same device or method that they used to scan in and enter the job site (QR Code Scan, Biometric Scan, or RFID/NFC Card Scan). If the job site is using a 3rd Party Facial scanner or ID Card scanner, the authorized worker can simply scan his face or scan his ID Card at the appropriate scanner, wait for the exit prompt (Beep Sound or screen message indicating that they have Checked Out) and walk out off the job site. Check-Out time can be recorded and pushed to company enterprise systems in real-time. When using the QR Code Scan, the authorized worker can scan the same QR Code located at the gate with their phone or mobile device. The authorized worker can get a splash screen from which the App can open a mobile or PC App version (dependent upon accessing device). Once opened, the App can direct the authorized worker to a secured logout page displaying the Job Site name and Location (Ex. Front Gate, Loading Dock, etc.). The authorized worker can then be prompted to select his Employer/Contactor from a dropdown menu created via an API call to the Company Enterprise system requesting Contractor Information. The authorized worker can then be prompted to select his name from a dropdown menu created via an API call to the company enterprise system requesting worker information or directly from the enrolled/authorized worker tables or list. The authorized worker can then select the Check Out button and check out of the job site. The authorized worker's Check-Out time can be recorded and pushed to Company enterprise systems in real-time.

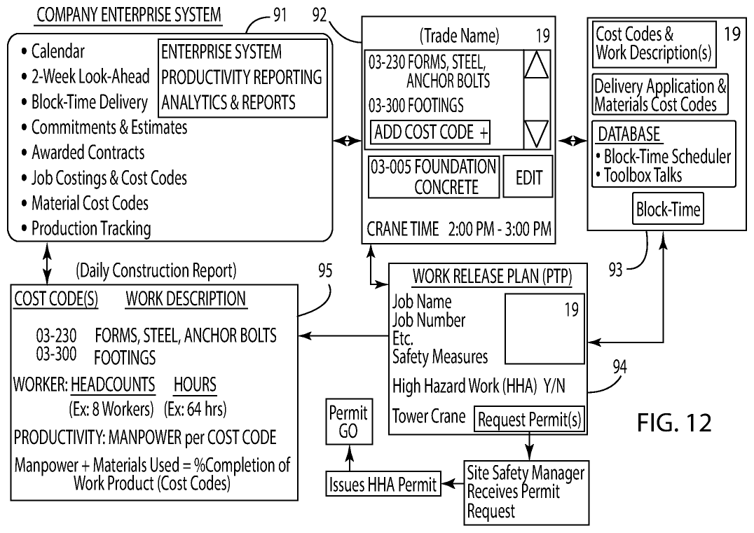

FIG. 12 is flowchart showing a daily workday using a pre-task plan in accordance with one embodiment. The enterprise system is the source for several types of information which can be pushed to a foreman (or another authorized worker selected by the system administrator). Step 91 shows the information can comprise, for example, a calendar, a 2 week look-ahead, a block-time delivery, commitments, and estimates, awarded contracts, and various cost codes. The PTP/work description can be auto-populated from the enterprise system project calendar. This work description can be edited based on the previous day's inputs, and/or the contractor or system administrator. Such editing can preferably be automatic based on the previous day's calendar inputs or other inputs from system administrators as needed in real-time. At step 92, the foreman would select a PTP and select predetermined cost codes, and optionally, materials deliveries and other scheduled events (such as crane time, for example). The various selections and schedules may be edited, such as by use of an edit button. At step 93, based on the cost code selections, a predefined work description is populated, including pre-determined toolbox talks. Toolbox talks are a series of pictorial narratives and descriptions of approved safety measures needed to perform a specific task, use of tool(s), and materials handling safely. In addition, ToolBox Talks are used in an informal group discussion that focuses on a particular safety issue. These tools can be used daily to promote department safety culture, as well as to highlight health and safety discussions on job sites. In accordance with a highly advantageous element, a list of toolbox talks may be provided, the toolbox talks can be assigned to a cost code, and information about the toolbox talks can be pushed to the authorized workers. Images and narratives about each pushed toolbox talk may be pushed to the screens of the computers and/or mobile devices of the foreman and other authorized workers. Typically, the authorized worker can be able to select via a button, which of the pushed toolbox talks he wishes to review. At step 94, based on the cost codes selected and schedule provided, a work release plan/PTP may be populated. This can include high hazard work in some instances. A worker can request a High Hazard permit via the app from the Site Safety Supervisor. At step 95, a report may be generated, such as a daily construction report.

From the foregoing disclosure and detailed description of certain embodiments, it can be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for presenting data about a construction site on a network of operatively connected computers, comprising, in combination, the steps of:
establishing authorized workers at the construction site authorized to complete at least a portion of a pre-task plan which corresponds to the authorized worker;
presenting the portion of the pre-task plan to the authorized worker;
generating inputs from the authorized worker corresponding to a change in status which are used to create reports; and
pushing reports to one or more selected parties on the cloud network based on the inputs from the authorized worker in real-time.

2. The method of claim 1 wherein the inputs generated by the authorized worker corresponding to the change in status comprises at least one of:
acknowledging the portion of the pre-task plan relating to the authorized worker, completing a task, presenting information about a status of at least one of equipment, materials, and authorized workers, presenting information about safety, and presenting information about an inspection.

3. The method of claim 1 wherein the selected parties comprise at least one of an agent of a general contractor, an agent of a subcontractor, the authorized worker who completed the pre-task plan, and other authorized workers who can be near the authorized worker who completed the pre-task plan.

4. The method of claim 1 wherein the portion of the pre-task plan is a daily work schedule of an authorized worker, wherein the daily work schedule is a subset of work to be done on the construction site for a given day for a given authorized worker, wherein the authorized workers are those who are supposed to be on the construction site for the given day pursuant to the daily work schedule; and
further comprising the step of logging into the network at the construction site, and comparing a reference database of authorized workers with a person logging into the network at the construction site to identify that person is an authorized worker authorized to complete at least a portion of the pre-task plan.

5. The method of claim 4 wherein the pre-task plan comprises a list of questions, and a subset of the list of questions which are specific to the authorized worker are presented to the person to confirm the person is an authorized worker.

6. The method of claim 1 further comprising the step of pulling enterprise resource planning data from an enterprise resource planning module comprising one or more cost codes, and auto-populating the one or more cost codes for selection by the authorized worker.

7. The method of claim 6 wherein the one or more cost codes are presented to the authorized worker on one of a tablet, smartphone and laptop operatively connected to the network using a drop-down menu.

8. The method of claim 1 wherein the authorized worker makes selections for input using a touchscreen on one of a tablet, smartphone and laptop operatively connected to the network.

9. The method of claim 8 further comprising presenting a schematic of a portion of the construction site, and the authorized worker touches a portion of the touchscreen to indicate percent (%) completion of a task and materials used.

10. The method of claim 1 wherein the authorized worker makes selections for input by answering Yes/No questions presented on one of a tablet, smartphone and laptop operatively connected to the network.

11. The method of claim 1 wherein the inputs of the authorized worker comprise at least one of voice data, talk-to-text data, pictorial data, and video data.

12. The method of claim 1 wherein the reports further comprise messages sent to the authorized worker.

13. A method for presenting data about a construction site to a network of operatively connected computers comprising, in combination, the steps of:
pulling enterprise resource planning data from an enterprise resource planning module, wherein the enterprise resource planning data comprises one or more cost codes;
generating a report about at least one aspect of the data of the construction site, wherein the report comprises the one or more cost codes;
and
pushing the report about the at least one aspect of the construction site data to one or more selected parties.

14. The method of claim 13 wherein the at least one aspect comprises information about at least one of manpower, contractors, materials, equipment, productivity, safety, and inspection.

15. The method of claim 14 wherein the manpower information comprises at least one of:
status of any person on the construction site;
illness of any authorized worker;
expected output of any authorized worker; and
actual output of any authorized worker.

16. The method of claim 14 wherein the materials information comprises at least one of:
materials entering the construction site, and materials status at the construction site; and
the equipment information comprises at least one of:
equipment entering the construction site, and equipment status at the construction site.

17. The method of claim 14 wherein the report tracks an aspect over time against a cost code.

18. The method of claim 14 wherein the report comprises at least one of a daily report, a notification of delay, and a notification of a failure to complete a required report.

19. The method of claim 14 further comprising a schematic of a portion of the construction site presented to a computer of an authorized worker, wherein the authorized worker can indicate daily work completed pictorially.

20. The method of claim 14 further comprising a list of toolbox talks, wherein the toolbox talks are assigned to a cost code, and information about the toolbox talks are pushed to the authorized workers.
